(19) United States
(12) Patent Application Publication
(10) Pub. No.: US 2015/0227549 A1
(43) Pub. Date: Aug. 13, 2015

(54) DEVICE AND METHOD FOR MANAGING FILES

(71) Applicant: MYDRIVES INC., Seoul (KR)

(72) Inventor: Sungsoo MOON, Bucheon-si, Gyeonggi-do (KR)

(73) Assignee: MYDRIVES INC., Seoul (KR)

(21) Appl. No.: 14/151,858

(22) Filed: Jan. 10, 2014

(30) Foreign Application Priority Data
Jan. 2, 2014 (KR) 10-2014-0000147

(51) Int. Cl. G06F 17/30

(52) U.S. Cl. CPC G06F 17/30203; G06F 17/30091; G06F 17/30106

(57) ABSTRACT

Disclosed are a device and a method for managing files, in which a file list of a user's files stored in at least one user device belonging to the user and at least one storage server providing a service to which the user has subscribed is converted into an integrated file list according to a preset form, and the converted integrated file list is stored. Through the integrated file list, all files stored in user devices belonging to one user or storage servers providing services to which one user has subscribed can be managed.

### CROSS-REFERENCE TO RELATED APPLICATION

This application claims priority from and the benefit under 35 U.S.C. §119(a) of Korean Patent Application No. 10-2014-0000147, filed on Jan. 2, 2014, which is hereby incorporated by reference for all purposes as if fully set forth herein.

### BACKGROUND OF THE INVENTION

1. Field of the Invention

The present invention relates generally to a file management technology, and more particularly, to a device and a method for integrally managing files that are managed through different file systems and are stored in mutually different mediums.

2. Description of the Prior Art

As the number of devices (e.g., a smart phone, a table Personal Computer (PC), a laptop computer, a PC, a Google Glass, and the like) used by a user increases, the user's files are dispersed in storage units (e.g., a hard disk, a Solid State Drive (SSD), and the like) within several devices. Although a cloud service (e.g., Dropbox, NDrive, and the like) has appeared in order to solve the dispersion, the file systems have been further dispersed due to a lack of capacity and simultaneous use of several cloud services. Further, as various internet-based application services (e.g., Facebook, Evernote, and the like) are preferred, user data has been further dispersed.

The dispersion of the user's file systems causes several problems. Among them, the first thing to think about is that it is difficult for the user to remember the location where files have been stored. For example, when the user wants to find a file to view a photo taken 3 years ago, the user may sequentially search a photo album of a smart phone, a storage medium of his own laptop computer, a cloud server such as N Drive, an photo album of a Social Networking Service (SNS) service such as Facebook, and the like and thereafter, may finally identify that the file is stored in his own desktop PC.

Secondly, file transfer between devices or between services is not easy. In general, a Universal Serial Bus (USB) cable or an e-mail is usually used for file transfer between the devices. However, in a case of the USB cable, there is an inconvenience to find the cable and connect the cable to the devices, and the maximum transmission speed of 12 Mbit/s based on a commonly used USB cable is not very high. Also, the USB cable is unavailable in direct file transfer between PCs. In a case of the e-mail, there is a limit in massive file transfer and a large amount of time is taken to transfer files (upload time and download time are separately required). Meanwhile, internet-based SNS services should also separately download and upload an individual file. For example, when a user wants to move an album from Cyworld to Facebook, the user cannot help but download all photos one by one and then, upload the photos to Facebook again.

Thirdly, there is a problem in file sharing. In order to share massive media content such as a movie with a friend, a user should store the file in a mobile hard disk or a massive USB memory and thereafter, directly meet the friend while carrying the device.

Meanwhile, although file transfer through a Peer to Peer (P2P) program such as Torrent has been recently used, there is a difficulty due to somewhat complex methodology by which the program should be set for file sharing every time.

Further, in storing and sharing files through a cloud service, there is a limit in capacity of a storage space provided on the cloud. Since high-definition media content has files with considerably large capacity, the currently provided cloud storage space entails a problem of a lack of capacity.

### PRIOR ART DOCUMENT

### Patent Document

Korea Patent Laid-Open Publication No. 2013-0068590, published on Jun. 26, 2013 (entitled “Method and metadata sever for managing storage device of cloud storage”)

### SUMMARY OF THE INVENTION

Accordingly, an aspect of the present invention is to provide a device and a method for integrally managing files that are managed by using a plurality of file systems.

In accordance with an aspect of the present invention, a service server for managing files is provided. The service server includes: a storage module for storing data; a communication module for communication; and a control module that receives, through the communication module, a file list of a user's files stored in at least one of at least one user device and at least one storage server providing a service to which the user has subscribed, converts the received file list into an integrated file list according to a preset form, and stores the converted integrated file list in the storage module.

The integrated file list may include information on a location where the files are actually stored.

The control module may search for a location of a file indicated by a request message in the integrated file list and transmit a response message having information on the location of the file to the user device, when receiving the request message for requesting a location of a specific file from the user device through the communication module.

The control module may discover the storage server storing a file associated with a specific file according to a preset algorithm by searching the integrated file list, and transmit a response message for an upload of the specific file to the discovered storage server to the user device through the communication module, when receiving a request message for requesting the upload of the specific file from the user device through the communication module.

The control module may discover the storage server currently storing a specific file by searching the integrated file list, download the specific file from the discovered storage server, and upload the downloaded specific file to a specific storage server, when receiving a request message for requesting a movement of the specific file to the specific storage server from the user device through the communication module.

In accordance with another aspect of the present invention, a method of managing files through a service server is provided. The method includes: receiving a file list of a user's files stored in at least one of at least one user device and at least one storage server providing a service to which the user has subscribed; and processing the received file list into an integrated file list according to a preset form and storing the processed integrated file list.

The integrated file list comprises information on a location where the files are actually stored.

According to the present invention as described above, the user devices 100 belonging to one user are brought into a cloud computing. This is possible because the user devices 100 are almost always turned on due to the development of a battery technology and are always connected to a network, namely, the internet while turned on. Accordingly, the individual user devices 100 have the nature of a server and functions as an individual cloud storage server configuring the cloud. The integrated file list is created in the service server 300 by integrating the user devices 100 which are brought into the cloud computing, actual cloud storage devices, and application servers providing various services, namely, storage servers 200. The service server 300 does not directly store a file and stores only the integrated file list having information as to where the file exists. Accordingly, when any user device 100 of the user accesses the service server 300, the user can search for and utilize the location where the specific file exists.

### BRIEF DESCRIPTION OF THE DRAWINGS

The above and other objects, features and advantages of the present invention will be more apparent from the following detailed description in conjunction with the accompanying drawings, in which:

FIG. 1 is a block diagram illustrating configurations of a file management system according to an embodiment of the present invention;

FIG. 2 is a block diagram illustrating configurations of a service server according to an embodiment of the present invention;

FIG. 3 is a block diagram schematically illustrating internal configurations of a user device according to an embodiment of the present invention;

FIGS. 4A and 4B are views illustrating an integration method for integrally managing file lists according to an embodiment of the present invention;

FIG. 5 is a signal flow diagram illustrating a cloud computing method for file management according to an embodiment of the present invention;

FIG. 6 is a signal flow diagram illustrating a cloud computing connection method for file management according to an embodiment of the present invention;

FIG. 7 is a signal flow diagram illustrating a method of searching for a file for file management according to an embodiment of the present invention;

FIG. 8 is a signal flow diagram illustrating a method of uploading a file for file management according to an embodiment of the present invention;

FIG. 9 is a signal flow diagram illustrating a method of moving a file for file management according to an embodiment of the present invention;

FIG. 10 is a signal flow diagram illustrating a method of downloading a file for file management according to an embodiment of the present invention; and

FIG. 11 is a signal flow diagram illustrating a method of sharing a file for file management according to an embodiment of the present invention.

### DETAILED DESCRIPTION OF THE EXEMPLARY EMBODIMENTS

Hereinafter, embodiments of the present invention will be described in more detail with reference to the accompanying drawings. At this time, it should be noted that identical elements in the drawings are denoted by identical reference numerals where possible. Further, detailed descriptions related to well-known functions or configurations capable of making subject matters of the present invention unnecessarily obscure will be omitted. For the same reason, in the accompanying drawings, some elements may be exaggerated, omitted, or schematically illustrated.

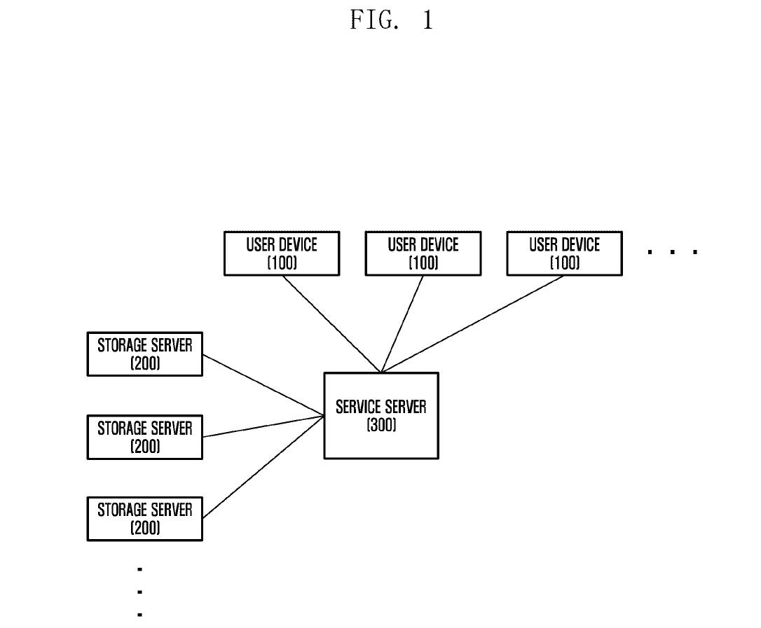

FIG. 1 is a block diagram illustrating configurations of a file management system according to an embodiment of the present invention.

Referring to FIG. 1, the file management system according to the embodiment of the present invention may include one or more user devices 100, one or more storage servers 200, and a service server 300.

The user devices 100 may connect with the service server 300 through a network in a wired or wireless manner. The user devices 100 may include a smart phone, a tablet Personal Computer (PC), a laptop computer, a phablet, a Personal Digital Assistant (PDA), an e-book reader, a notebook computer, and the like. A plurality of user devices 100 may be operated while different Operating Systems (OSs) are installed therein, respectively, and the operating systems may include iOS, Symbian, Android, Windows, MAC, Linux, Unix, and the like. Accordingly, the user devices 100 manage files through mutually different file systems.

The storage servers 200 are installed on a network to provide services associated with files generated through the user devices 100. The services associated with the files include all services for storing users' files in the storage server 200. For example, the services associated with the files may include a web storage service such as Dropbox, Skydrive, Google drive, NDrive, Evernote, and the like, a Social Network Service (SNS) such as Facebook, and a service for providing storage, upload, and download of files by using File Transfer Protocol (FTP), Secure FTP or Secure shell FTP (SFTP), and the like.

The service server 300 manages files of all users stored in the user devices 100 or the storage servers 200 for each of the users. Particularly, the service server 300 manages the files stored in the user devices 100 or the storage servers 200 through an integrated file list in a preset form. Although actual files have not been stored in the integrated file list, the integrated file list includes information for identifying files and location information on a location where the corresponding file has been stored. Here, the location information may be information for identifying a device storing the corresponding file therein, or a physical address or a logical address where the corresponding file has been stored.

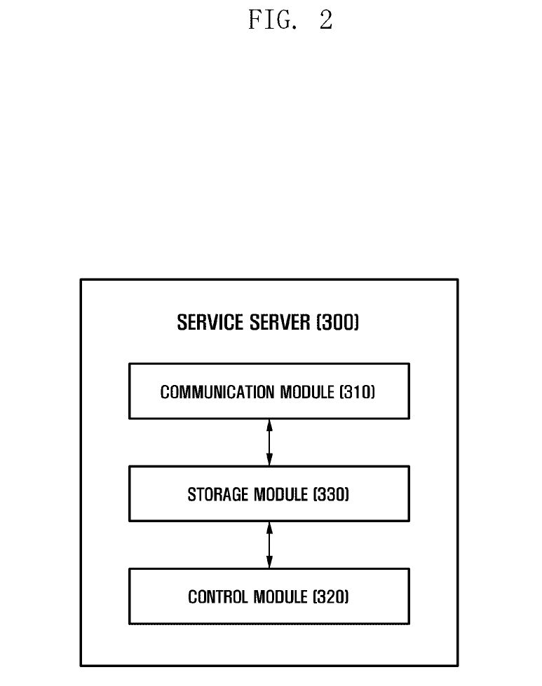

FIG. 2 is a block diagram illustrating configurations of a service server according to an embodiment of the present invention.

The service server according to the embodiment of the present invention includes a communication module 310, a storage module 320, and a control module 330.

The communication module 310 communicates with a plurality of user devices 100 and a plurality of storage servers 200 through a network to transmit/receive data to/from the user devices 100 and the storage servers 200. Here, the data may include various messages according to embodiments of the present invention as well as a file list.

The storage module 320 serves to store programs and data required for an operation of the service server 300, and may be divided into a program area and a data area. The program area may store a program for controlling an overall operation of the service server 300, an Operating System (OS) for booting up the service server 300, application programs, and the like. The data area stores the integrated file list according to the embodiment of the present invention. The various data to be stored in the storage module 320 may be deleted, changed, or added according to a user's manipulation. Particularly, the storage module 320 includes a cache and a storage.

The control module 330 may control an overall operation of the service server 300 and a signal flow between internal blocks of the service server 300, and perform a data processing function. The control module 300 may include a Central Process Unit (CPU), an application processor, and the like.

The control module 330 may receive a list of files stored in at least one user device 100 or at least one storage server 200 through the communication module 310, and may create an integrated file list by processing or converting the received file list into a preset form. Then, the control module 330 stores the created integrated file list in the storage module 320.

The control module 330 may receive, through the communication module 310, a file list of a user's files stored in at least one user device 100 belonging to the user and at least one storage server 200 providing a service to which the user has subscribed. In a case of the storage server 200, the control module 330 may receive a credential for access to the storage server 200 from the user device 100, access the storage server 200 by using the received credential, and receive the file list of the user's files stored in the storage server 200. Thereafter, the control module 330 converts the received file list into an integrated file list according to a preset form. Subsequently, the control module 330 stores the converted integrated file list in the storage module 320. Here, the integrated file list includes information on a place where the files have been actually stored. Accordingly, the control module 330 may manage all the files created by the user through a single integrated file list. The user device 100 may transmit a request message for requesting a location of a specific file in order to search for a location of a specific file among the user's files, to download the specific file onto a specific user device 100 among user devices 100 belonging to the user, or to share the specific file with a user device 100 belonging to another user. When receiving the request message for requesting the location of the aforementioned specific file from the user device 100 through the communication module 310, the control module 330 may discover the location of the specific file indicated by the received request message by searching the integrated file list stored in the storage module 320, and may transmit a response message including location information representing the location of the specific file to the user device 100 through the communication module 310.

Meanwhile, the user device 100 may upload the specific file to the storage server 200. In this case, it is desirable to upload files having similar properties to the same storage server 200. To this end, the user device 100 may transmit a request message for requesting an upload of the specific file to the service server 300. Accordingly, the control module 330 may receive the request message for requesting the upload of the specific file from the user device 100 through the communication module 310. The request message for requesting the upload of the specific file includes properties of the file. The properties may include, for example, a type of the file such as a file extension, an application having created the file, a device having created the file, and the like. Then, the control module 330 searches the integrated file list stored in the storage module 320 to discover the storage server 200 storing a file associated with the specific file according to a preset algorithm. Here, discovering the storage server 200 storing the file associated with the specific file according to the preset algorithm may correspond to, for example, discovering the storage server 200 storing the file having similar properties. Next, the control module 330 may transmit a response message for allowing for an upload of the specific file to the discovered storage server 200, to the user device 100 through the communication module 310. Thus, the user device 100 may upload the corresponding file to the corresponding storage server 200.

Further, the user device 100 may transmit a request message for requesting a movement of the specific file to a specific storage server 200. The control module 330 may accordingly receive the request message for requesting the movement of the specific file to the specific storage server 200, from the user device 100 through the communication module 310. Then, the control module 330 searches the integrated file list to discover a storage server 200 currently storing the specific file. Namely, the control module 330 discovers, from the integrated file list, a location where the specific file has been stored. Hereby, the control module 330 may discover the storage server 200 storing the specific file. Thereafter, the control module 330 may download the specific file from the discovered storage server 200 through the communication module 310, and may upload the downloaded specific file to the specific storage server 200 designated by the user device 100 through the communication module 310.

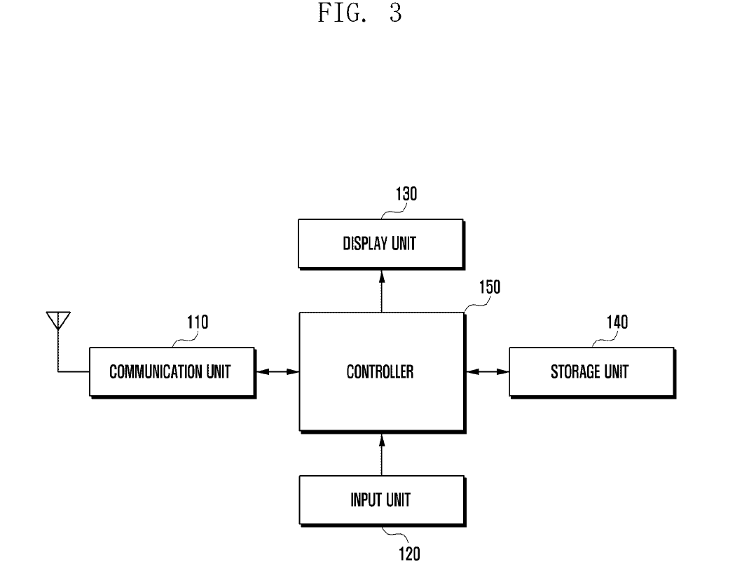

FIG. 3 is a block diagram schematically illustrating internal configurations of a user device according to an embodiment of the present invention.

Referring to FIG. 3, the user device 100 according to the embodiment of the present invention includes a communication unit 110, an input unit 120, a display unit 130, a storage unit 140, and a controller 150.

The communication unit 110 transmits/receives data to/from a storage server 200 or a service server 300 through a network. When performing wireless communication, the communication unit 110 may be configured with a Radio Frequency (RF) transmitter that up-converts and amplifies a frequency of a transmitted signal, and an RF receiver that low-noise amplifies a received signal and down-converts a frequency of the received signal. When performing wired communication, the communication unit 110 may be configured with a wired transceiver that transmits/receives data through a connected line. Namely, the communication unit 110 may receive data from the storage server 200 or the service server 300 to output the received data to the controller 150, and may transmit the data output from the controller 150 to the storage server 200 or the service server 300. The data transmitted by the communication unit 110 may include a file list.

The input unit 120 receives an input through a user's key manipulation for control of the user device 100 and generates an input signal to transfer the generated input signal to the controller 150. The input unit 120 may include any one of a power key for power on/off, a number key, and a direction key, and may be formed as a predetermined function key on one surface of the user device 100. Functions of the various keys included in the input unit 120 may be replaced by the display unit 130, and when all functions may be exclusively performed by the display unit 130, the input unit 120 may be omitted.

The display unit 130 visually provides a menu, data, function setting information, and other various pieces of information of the user device 100 to a user. The display unit 130 performs a function of outputting a boot-up screen, a standby screen, a menu screen, and other application screens of the user device 100. When the display unit 130 is formed of a touch screen, the display unit 130 may perform some or all of functions of the input unit 120 instead of the input unit 120. The display unit 130 may be formed of a Liquid Crystal Display (LCD), an Organic Light Emitting Diodes (OLED), an Active Matrix Organic Light Emitting Diodes (AMOLED), or the like.

The storage unit 140 serves to store programs and data required for an operation of the user device 100, and may be divided into a program area and a data area. The program area may store a program for controlling an overall operation of the user device 100, an Operating System (OS) for booting up the user device 100, application programs, and the like. The data area is an area where user data created according to use of the user device 100 is stored. Further, the storage unit 140 may store various data that is created while a user uses the user device 100. The various data to be stored in the storage unit 140 may be deleted, changed, or added according to a user's manipulation.

The controller 150 may control an overall operation of the user device 100 and a signal flow between internal blocks of the user device 100, and perform a data processing function. The controller 150 may include a Central Process Unit (CPU), an application processor, and the like.

The controller 150 may transmit a file list of a user's files stored in the storage unit 140 to the service server 300 through the communication unit 110. The controller 150 may connect with at least one storage server 200 providing a service to which a user has subscribed, and may acquire a credential through which the controller 150 may access the storage server 200. Thereafter, the controller 150 may transmit the credential to the service server 300 through the communication unit 110 such that the service server 300 may receive the file list of the user's files stored in the storage server 200 from the storage server 200. Accordingly, the service server 300 may receive the file list of all files of a specific user to create an integrated file list.

Meanwhile, the controller 150 may transmit a request message for requesting a location of a specific file to the service server 300 though the communication unit 110. Thus, the service server 300 may search the integrated file list to discover the location of the specific file and transmit a response message including location information representing the location of the specific file. Then, the controller 150 may receive the response message through the communication unit 110 and acquire the location information representing the location of the specific file from the received response message. The controller 150 having acquired the location information may display the location information, download the specific file with reference to the location information, or share the specific file with another user by transmitting the location information to a user device 100 of the another user such that the user device 100 of the another user may download the specific file.

Further, the controller 150 may transmit a request message for requesting an upload of the specific file to the service server 300 though the communication unit 110. The request message for requesting the upload of the specific file includes properties of the file. The properties may include, for example, a type of the file such as a file extension, an application having created the file, a device having created the file, and the like. Then, the service server 300 searches the integrated file list to discover the storage server 200 storing files associated with specific file according to a preset algorithm. For example, the service server 300 may discover the storage server 200 storing files having similar properties. Thereafter, the service server 300 may transmit, to the user device 100, a response message for allowing for an upload of the specific file to the discovered storage server 200. Accordingly, the controller 150 may receive the response message through the communication unit 110 to upload the corresponding file to the corresponding storage server 200 designated by the response message.

The controller 150 may transmit a request message for requesting the service server 300 to move the specific file to a specific storage server 200, to the service server 300 through the communication unit 110. Then, the service server 300 searches the integrated file list to discover a storage server 200 currently storing the specific file. Thereafter, the service server 300 may download the specific file from the discovered storage server 200 and then, may upload the downloaded specific file to the specific storage server 200 designated by the user device 100.

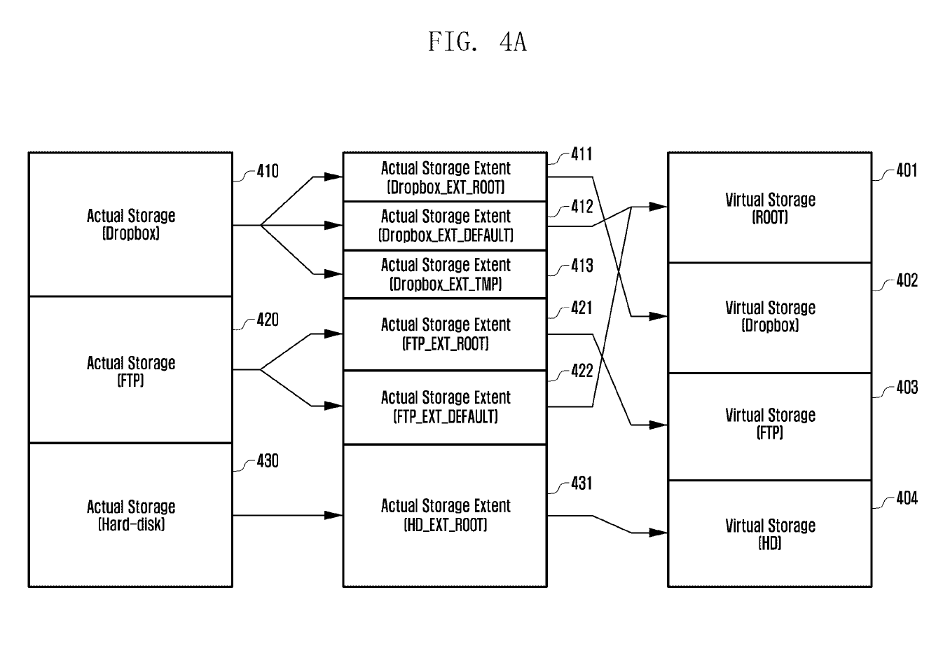

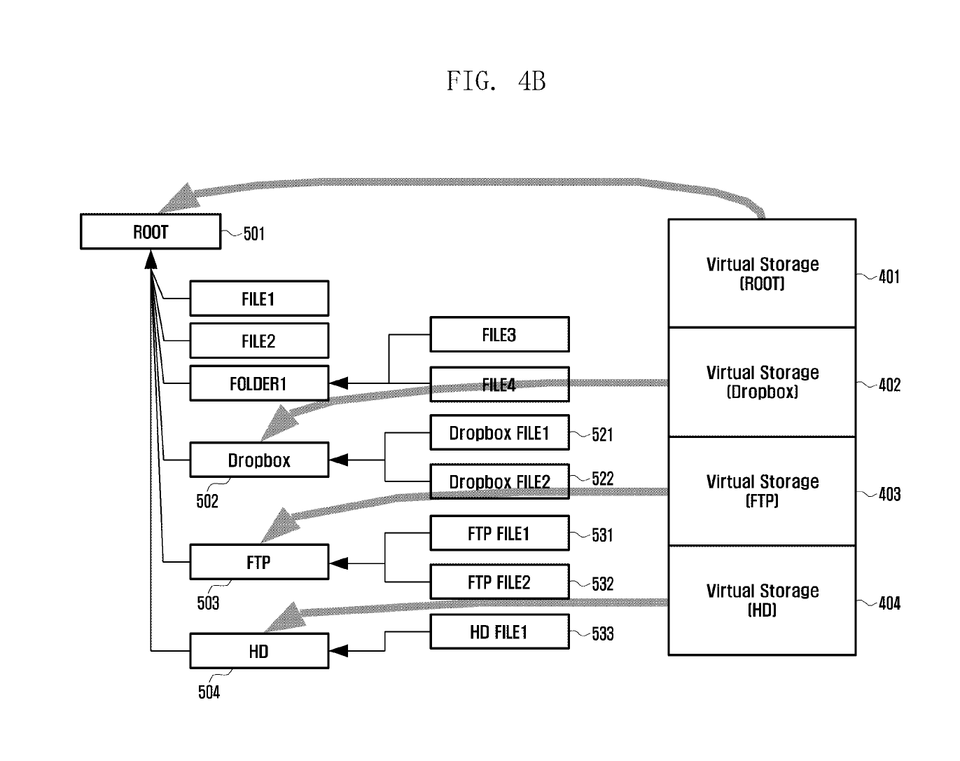

FIGS. 4A and 4B are views illustrating an integration method for integrally managing file lists according to an embodiment of the present invention.

Referring to FIG. 4A, reference numerals 410 and 420 denote, for example, actual file lists for files stored in a storage server 200 providing a file related service. For example, it is assumed that the reference numeral 410 denotes the actual file list of files stored in the Dropbox and the reference numeral 420 denotes the actual file list stored in an FTP site. Further, it is assumed that reference numeral 430 denotes an actual file list of files stored in a hard disk of a specific user device 100.

The actual file lists are transferred to a service server 300 by the user device 100 or a storage server 200. The service server 300 converts the actual file lists into virtually integrated file lists according to a preset form.

For example, the service server 300 divides the actual file lists through the preset form according to the need. Here, reference numerals 411, 412, and 413 denote file lists into which the actual file list 410 of the files stored in the Dropbox is divided, and reference numerals 421 and 422 denote file lists into which the actual file list 420 stored in the FTP site is divided. Thereafter, the service server 300 classifies the divided file lists according to the form set in advance. Reference numerals 401, 402, 403, and 404 denote the classified file lists.

Referring to FIG. 4B, the service server 300 converts the classified file lists into virtually integrated file lists. Reference numerals 501 to 504 and 521 to 541 represent an integrated file list in which the file lists for the respective devices (the user device 100 or the storage server 200) are defined in a tree structure or a directory structure with ROOT serving as a reference. The integrated file list includes information on a file and information on a location where the file has been stored.

Hereinafter, a method of managing files according to an embodiment of the present invention will be described in more detail.

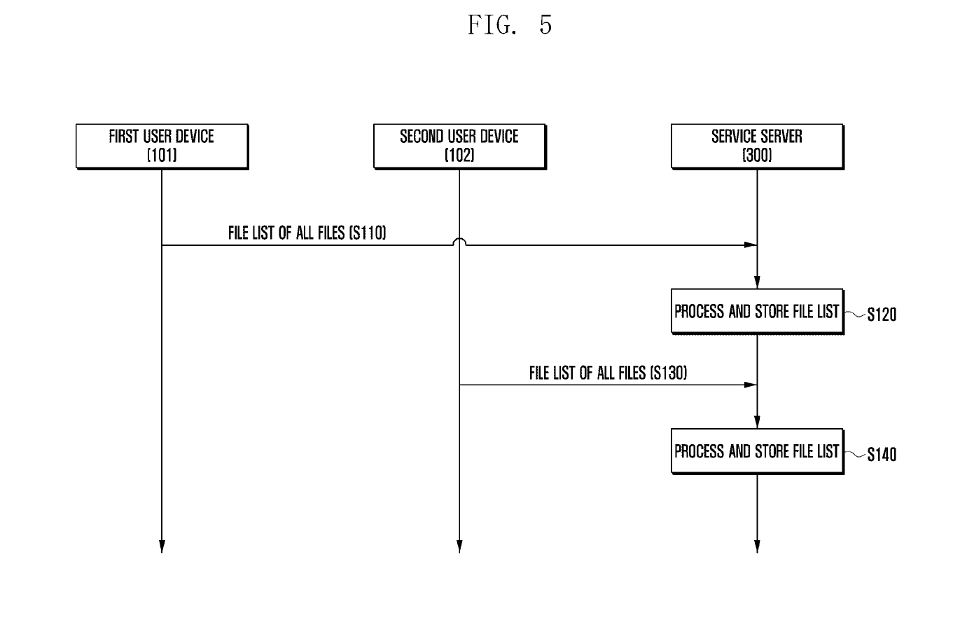

FIG. 5 is a signal flow diagram illustrating a cloud computing method for file management according to an embodiment of the present invention. First and second user devices 101 and 102 are illustrated in FIG. 5. The first and second user devices 101 and 102 belong to the same user. For example, the first user device 101 may be a smart phone with an Android operating system, and the second user device 102 may be a laptop computer or a notebook computer with Windows operating system.

Referring to FIG. 5, the first user device 101 transmits a file list of all files stored therein to a service server 300, in step S110. Then, the service device 300 having received the file list processes the file list of all the files into an integrated file list in a preset form and stores the integrated file list, in step S120.

The second user device 102 transmits a file list of all files stored therein to the service server 300, in step S130. Then, the service device 300 having received the file list processes the file list of all the files into the same form of the integrated file list as in step S120 and stores the integrated file list, in step S140.

According to the present invention, as described above, the service device 300 may receive the file list of all the files stored in each of the plurality of user devices 101 and 102 and integrate the file list into the same form of the integrated file list.

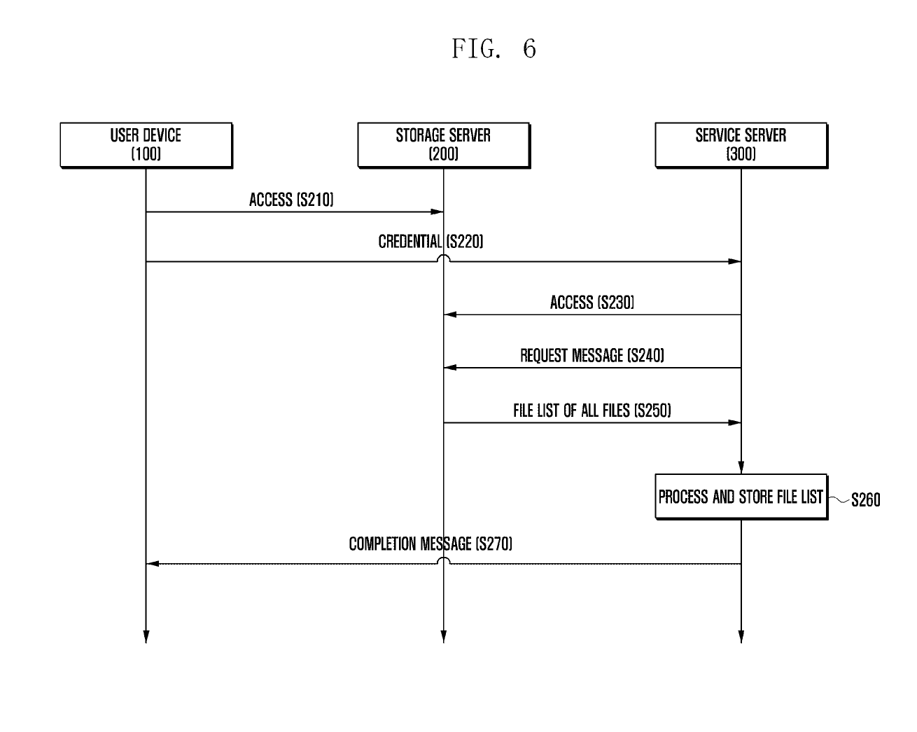

FIG. 6 is a signal flow diagram illustrating a cloud computing connection method for file management according to an embodiment of the present invention. A user device 100 is illustrated in FIG. 6, and it is assumed that the user device 100 uses a specific operating system. Here, the operating system may include Android, Windows, or the like. Further, it is assumed that a user of the user device 100 has subscribed to a service provided by a storage server 200. Here, the storage server 200 may correspond to a server for providing a cloud service. The cloud service may include Dropbox, Skydrive, NDrive, Google Drive, or the like. Further, the storage server 200 may correspond to a server for providing an SNS service. The SNS service may representatively include the Facebook service. Alternatively, the storage server 200 may also correspond to a file server for providing a file service, for example, a server using the FTP.

Referring to FIG. 6, the user device 100 accesses the storage server 200 and may acquire a credential, in step S210. Here, the credential may be a credential for an account of the user of the user device 100. Then, the user device 100 transmits the credential to a service server 300, in step S220.

The service server 300 accesses the storage server 200 through the credential, in step S230. Thereafter, the service server 300 transmits a request message for requesting a file list of files that have been stored in the storage server 200 for the user of the user device 100, in step S240. The storage server 200 transmits the file list to the service server 300, in step S250. The service server 300 may process the corresponding file list into an integrated file list in the same preset form as in steps S120 and S140 illustrated in FIG. 5, and may store the integrated file list, in step S260. Next, the service server 300 transmits, to the user device 100, a completion message for informing that the procedure is completed, in step S270.

If the procedures illustrated in FIGS. 5 and 6 are performed, the service server 300 may receive the file list of all the files stored in the storage server 200 as described with reference to FIG. 6, and may integrate the file list into a single integrated file list in the same form as the integrated file list of the user device 100 described with reference to FIG. 5. The procedures illustrated in FIGS. 5 and 6 may be performed irrespective of the order thereof. Although one storage server 200 has been exemplified in FIG. 6, the service server 300 may receive, through the same procedure, file lists of files stored in a plurality of storage servers 200 operating services to which the user of the user device 100 has subscribed, and may integrate the file lists into the single integrated file list in the same form.

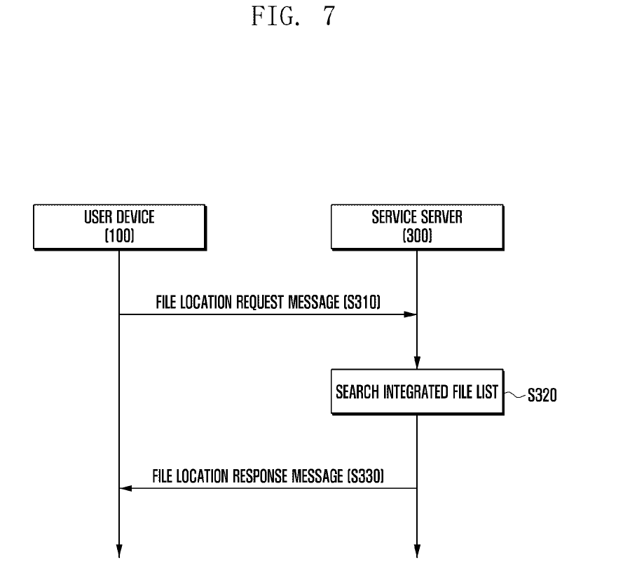

FIG. 7 is a signal flow diagram illustrating a method of searching for a file for file management according to an embodiment of the present invention. First, it is assumed that the service server 300 has received file lists of all of a user's files stored in a plurality of user devices 100 belonging to the user and a plurality of storage servers 200 providing services to which the user has subscribed, and has stored an integrated file list obtained by processing the file lists into the same form, through the procedures as illustrated in FIGS. 5 and 6.

Referring to FIG. 7, when the user inputs an inquiry as to a file location in order to identify the location where a specific file has been stored, the corresponding user device 100 transmits a file location request message to the service server 300, in step S310. Here, the file location request message is to request the location where the specific file has been stored. The service server 300 searches the integrated file list stored in advance, in step S320. The integrated file list has already been stored through the procedures illustrated in FIGS. 5 and 6.

When the location of the corresponding file is discovered, the service server 300 transmits, to the user device 100, a file location response message including location information representing the location where the file has been stored, in step S330. The user device 100 may accordingly display the location of the corresponding file.

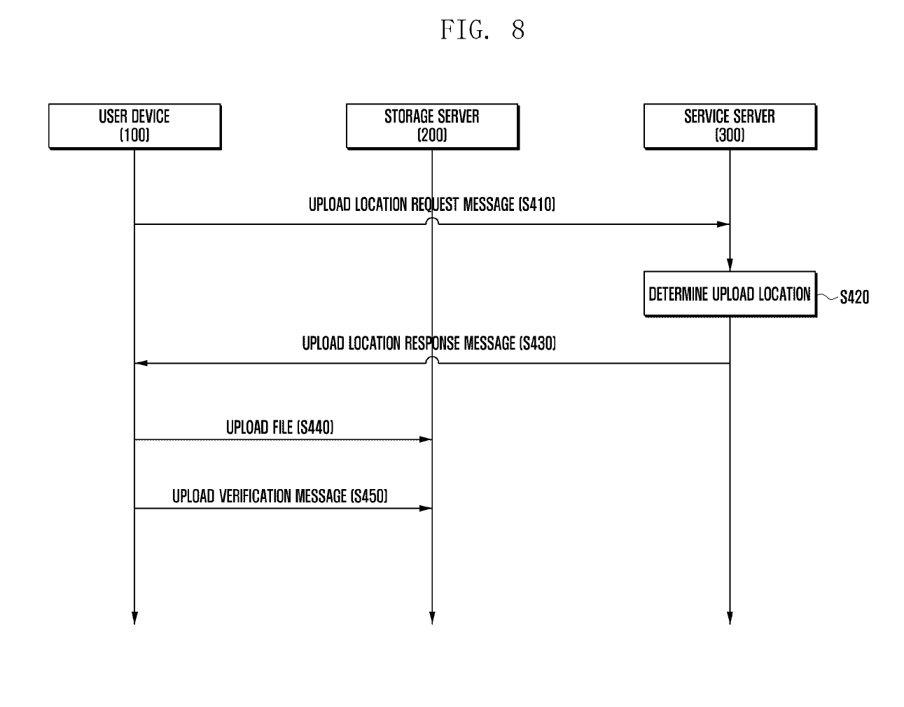

FIG. 8 is a signal flow diagram illustrating a method of uploading a file for file management according to an embodiment of the present invention. First, it is assumed that the service server 300 has received file lists of all of a user's files stored in a plurality of user devices 100 belonging to the user and a plurality of storage servers 200 providing services to which the user has subscribed, and has stored an integrated file list obtained by processing the file lists into the same form, through the procedures as illustrated in FIGS. 5 and 6.

Referring to FIG. 8, when the user inputs a command to upload a specific file, the corresponding user device 100 transmits an upload location request message to the service server 300, in step S410. The upload location request message may include a file name, properties, and the like of a file to be uploaded. The properties may include, for example, a type of the file such as a file extension, an application having created the file, a device having created the file, and the like.

The service server 300 may search the integrated file list stored in advance and determine the storage server 200 storing a file most relevant to the file to be uploaded, among the plurality of storage servers 200 (or the plurality of user devices 100), as an upload location according to a preset algorithm. For example, the determination of the upload location may correspond to discovering the storage server 200 storing a file having similar properties. At this time, if the location where the file will be uploaded is determined, location information on the corresponding file is added to the integrated file list.

Thereafter, the service server 300 transmits an upload location response message informing of the determined location (i.e., the determined device) to the user device 100, in step S430. Here, it is assumed that the upload location determined by the service server 300 is the storage server 200. The user device 100 uploads the corresponding file to the storage server 200, in step S440. When the upload is completed, the storage server 200 transmits an upload verification message informing of the completion of the upload to the user device 100, in step S450.

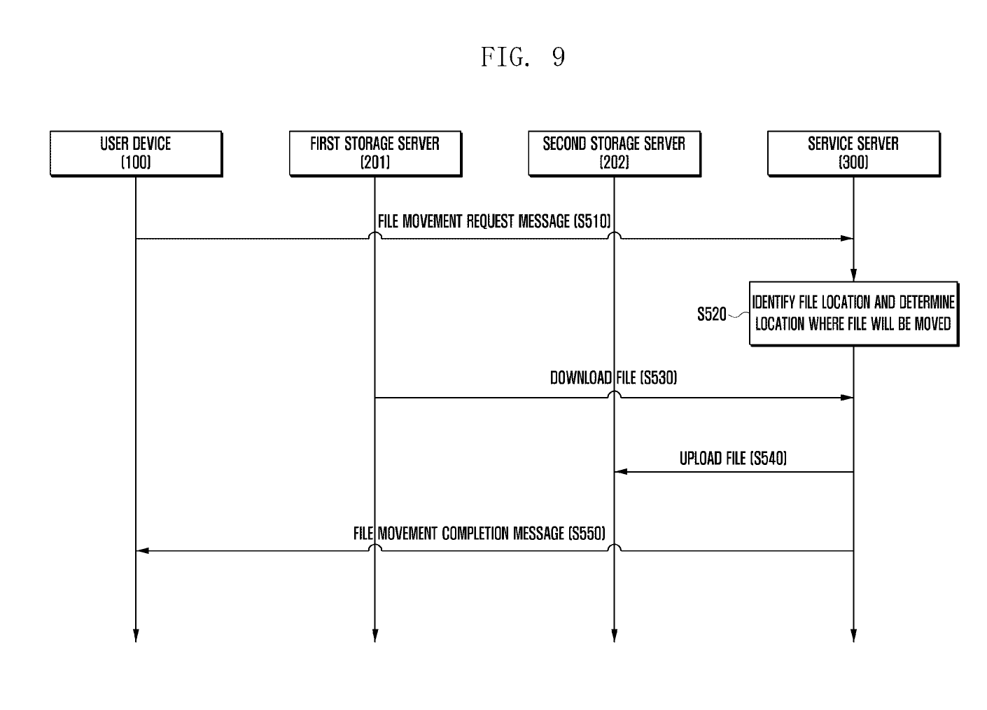

FIG. 9 is a signal flow diagram illustrating a method of moving a file for file management according to an embodiment of the present invention. In FIG. 9, it is assumed that the service server 300 has received file lists of all of a user's files stored in a plurality of user devices 100 belonging to the user and a plurality of storage servers 200 providing services to which the user has subscribed, and has stored an integrated file list obtained by processing the file lists into the same form, through the procedures as illustrated in FIGS. 5 and 6.

Referring to FIG. 9, the corresponding user device 100 transmits a file movement request message for requesting a movement of a specific file to the service server 300, in step S510.

The service server 300 having received the file movement request message identifies a location of the specific file and determines a location where the file will be moved, in step S520. Accordingly, the integrated file list is updated. Here, it is assumed that the current location of the specific file corresponds to a first storage server 200 and the location where the file will be moved corresponds to a second storage server 200. The service server 300 downloads the specific file from the first storage server 201 in step S530, and uploads the specific file to the second storage server 202 in step S540.

Thereafter, the service server 300 transmits, to the user device 100, a file movement completion message informing that the file has been moved from the first storage server 201 to the second storage server 202, in step S550.

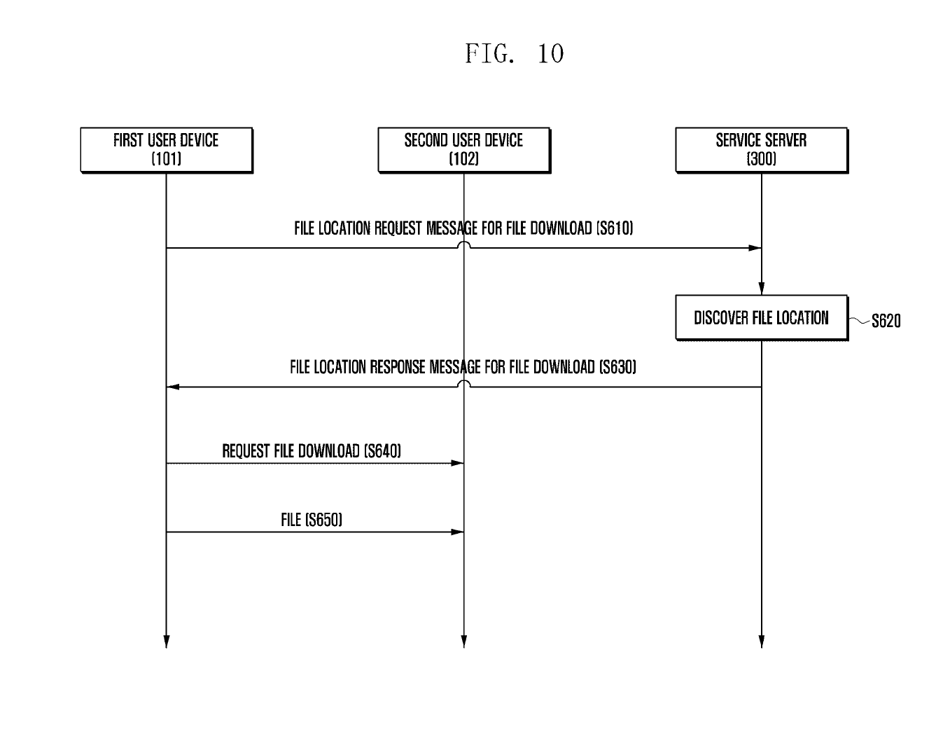

FIG. 10 is a signal flow diagram illustrating a method of downloading a file for file management according to an embodiment of the present invention. First and second user devices 101 and 102 belong to the same user. For example, the first user device 101 may be a smart phone with an Android operating system, and the second user device 102 may be a laptop computer or a notebook computer with Windows operating system. In FIG. 10, it is assumed that the service server 300 has received file lists of all of a user's files stored in a plurality of user devices 101 and 102 belonging to the user and a plurality of storage servers 200 providing services to which the user has subscribed, and has stored an integrated file list obtained by processing the file lists into the same form, through the procedures as illustrated in FIGS. 5 and 6.

Referring to FIG. 10, for a download of a specific file, the first user device 101 transmits, to the service server 300, a file location request message for requesting a location of the file to be downloaded, in step S610.

The service server 300 having received the file location request message discovers the requested location of the specific file through the integrated file list, in step S620. Thereafter, the service server 300 transmits a file location response message to the first user device 101, in step S630. The file location response message includes location information representing the location of the specific file. For example, it is assumed that the location where the specific file is currently stored corresponds to the second user device 102 and an Internet Protocol (IP) address where the file has been stored corresponds to 192.248.4.41. The file download response message may include information for identifying the second user device 102 in which the file has been stored and the IP address 192.248.4.41, as the location information.

The first user device 101 having received the file location response message requests a file download from the second user device 102 by using the location information included in the file location response message, in step S640. Thereafter, the first user device 101 downloads the file from the second user device 102, in step S650.

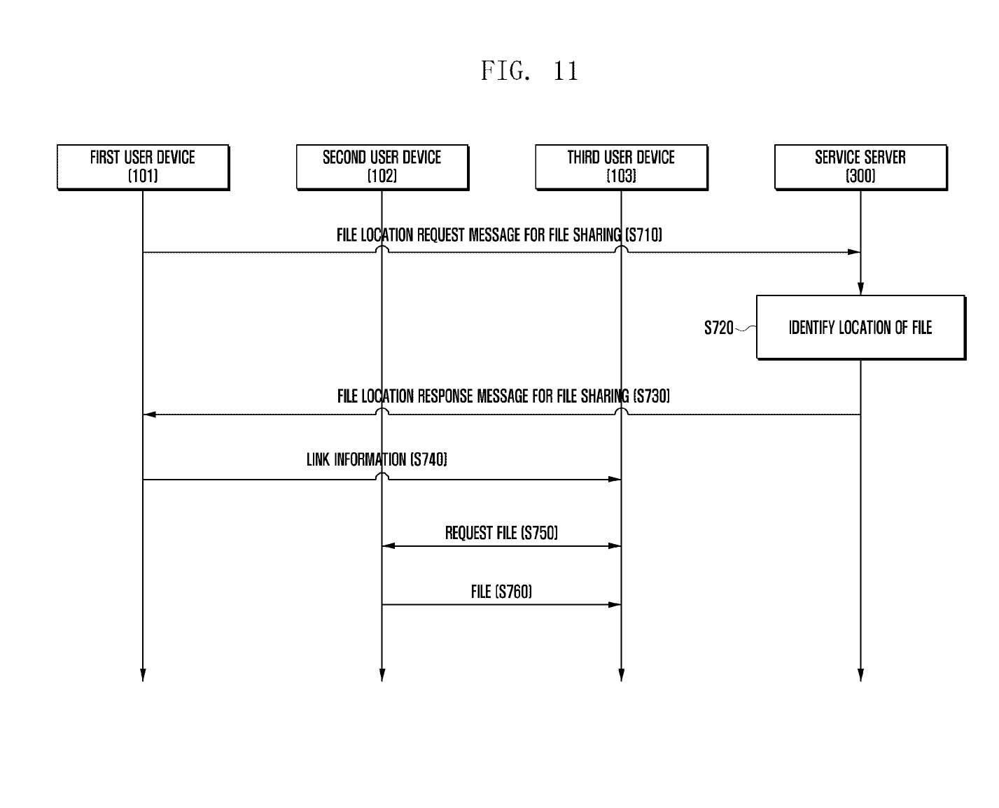

FIG. 11 is a signal flow diagram illustrating a method of sharing a file for file management according to an embodiment of the present invention. First and second user devices 101 and 102 belong to the same user, and a third user device 103 belongs to another user. For example, the first user device 101 may be a smart phone with an Android operating system, and the second user device 102 may be a laptop computer or a notebook computer with Windows operating system. Further, the third user device 103 may be device with iOS operating system. In FIG. 11, it is assumed that the service server 300 has received file lists of all of a user's files stored in a plurality of user devices 101 and 102 belonging to the user and a plurality of storage servers 200 providing services to which the user has subscribed, and has stored an integrated file list obtained by processing the file lists into the same form, through the procedures as illustrated in FIGS. 5 and 6.

In FIG. 11, it is assumed that a user of the first user device 101 desires to share files with a user of the third user device 103. According to a request of the user of the first user device 101, the first user device 101 transmits, to the service server 300, a file location request message for requesting information on a location of a specific file for sharing of the specific file, in step S710.

The service server 300 having received the file location request message identifies a current location of the file by searching the integrated file list, in step S720. Thereafter, the service server 300 transmits a file location response message to the first user device 101, in step S730. The file location response message includes information on the location where the file has been stored. For example, it is assumed that the location where the specific file is currently stored corresponds to the second user device 102 and an address where the file has been stored corresponds to md.gg/aa/myfile. The file location response message may include information for identifying the second user device 102 and the address “md.gg/aa/myfile”, as the information on the location where the file has been stored.

The first user device 101 having received the file location response message transmits the location information representing the location where the file has been stored to the third user device 103 through a link information form, in step S740. Then, the third user device 103 requests the file from the second user device 102 in step S750 and receives the file in step S760.

As described above, according to the present invention, the user devices 100 belonging to one user are brought into the cloud computing. This is possible because the user devices 100 are almost always turned on due to the development of a battery technology and are always connected to a network, namely, the internet while turned on. Accordingly, the individual user devices 100 have the nature of a server and function as individual cloud storage servers that can be utilized as in a cloud computing system. The integrated file list is created in the service server 300 by integrating the user devices 100 which are brought into the cloud computing, actual cloud storage devices, and application servers providing various services, namely, storage servers 200. The service server 300 does not directly store a file and stores only the integrated file list having information as to where the file exists. Accordingly, when any user device 100 of the user accesses the service server 300, the user can search for and utilize the location where the specific file exists.

The method for managing files according to the present invention may be implemented in a software form that can be read through various computer means, and may be recorded in a computer readable recording medium. Here, the recording medium may include a program command, a data file, a data structure, and the like independently or in combination. The program command recorded in the recording medium may be things specially designed and configured for the present invention, or things that are well known to and can be used by those skilled in the computer software related art. For example, the recording medium includes a magnetic media such as a hard disk, a floppy disk, and a magnetic disk, an optical media such as a Compact Disk Read Only Memory (CD-ROM) and a Digital Video Disk (DVD), a magneto-optical media such as a floptical disk, and a hardware device specially configured to store and execute program commands, such as a ROM, a Random Access Memory (RAM), a flash memory, a Solid State Disk (SSD), a Hard Disk Drive (HDD), and the like. The program command may include not only a machine language code made by a compiler but also a high-level language code that can be executed by a computer using an interpreter.

Meanwhile, the embodiments of the present invention disclosed in the present specification and the drawings have been presented to easily explain technical contents of the present invention and help comprehension of the present invention, and do not limit the scope of the present invention. It is obvious to those skilled in the art to which the present invention pertains that other modified embodiments based on the spirit of the present invention can be made in addition to the embodiments disclosed herein.

What is claimed is:

1. A service server for managing files comprising:
a storage module for storing data;
a communication module for communication; and
a control module that receives, through the communication module, a file list of a user's files stored in at least one of at least one user device and at least one storage server providing a service to which the user has subscribed, converts the received file list into an integrated file list according to a preset form, and stores the converted integrated file list in the storage module.

2. The service server of claim 1, wherein the integrated file list comprises information on a location where the files are actually stored.

3. The service server of claim 2, wherein the information on the location where the files have been actually stored comprises identification information on a device actually storing the files among the user device and the storage server.

4. The service server of claim 3, wherein the information on the location where the files are actually stored further comprises IP address information of the device actually storing the files.

5. The service server of claim 1, wherein the control module searches for a location of a file indicated by a request message in the integrated file list and transmits a response message having information on the location of the file to the user device, when receiving the request message for requesting a location of a specific file from the user device through the communication module.

6. The service server of claim 1, wherein the control module discovers the storage server storing a file associated with a specific file according to a preset algorithm by searching the integrated file list, and transmits a response message for an upload of the specific file to the discovered storage server to the user device through the communication module, when receiving a request message for requesting the upload of the specific file from the user device through the communication module.

7. The service server of claim 1, wherein the control module discovers the storage server currently storing a specific file by searching the integrated file list, downloads the specific file from the discovered storage server, and uploads the downloaded specific file to a specific storage server, when receiving a request message for requesting a movement of the specific file to the specific storage server from the user device through the communication module.

8. A method of managing files through a service server, comprising:
receiving a file list of a user's files stored in at least one of at least one user device and at least one storage server providing a service to which the user has subscribed; and
processing the received file list into an integrated file list according to a preset form and storing the processed integrated file list.

9. The method of claim 8, wherein the integrated file list comprises information on a location where the files are actually stored.

10. The method of claim 8, further comprising:
searching for a location of a file indicated by a request message in the integrated file list and transmitting a response message having information on the location of the file to the user device, when receiving the request message for requesting a location of a specific file from the user device through the communication module.

11. The method of claim 8, further comprising:
discovering the storage server storing a file associated with a specific file according to a preset algorithm by searching the integrated file list and transmitting a response message for an upload of the specific file to the discovered storage server to the user device through the communication module, when receiving a request message for requesting the upload of the specific file from the user device through the communication module.
